(19) United States
(12) Patent Application Publication
(10) Pub. No.: US 2026/0286618 A1
(43) Pub. Date: Sep. 24, 2026

(54) TIMBER RAIL CROSSTIE PRESERVATION

(71) Applicant: COPPER CARE WOOD PRESERVATIVES, INC., Columbus, NE (US)

(72) Inventor: William ABBOTT, Humphrey, NE (US)

(73) Assignee: COPPER CARE WOOD PRESERVATIVES, INC., Columbus, NE (US)

(21) Appl. No.: 19/472,295

(22) PCT Filed: Apr. 16, 2024
(86) PCT No.: PCT/AU2024/050359

§ 371 Date: Oct. 3, 2025

(30) Foreign Application Priority Data
Nov. 9, 2023 (AU) 2023903593

(51) Int. Cl. E01B 3/10

(52) U.S. Cl. CPC E01B 3/10

(57) ABSTRACT

A process for preserving timber rail crossties involves an initial treatment with an inorganic borate wood preservative, followed by encasement in multiple plastic sleeves. The chosen preservative is effective against various pests and has lower toxicity than traditional options like creosote and CCA, addressing health and environmental concerns. Although the preservative's water solubility raises potential leaching issues, these are mitigated by wrapping the treated crossties in several differentiated plastic layers. The inner layers adhere to the wood, while the outer layers interface with the smoother inner surfaces, enhancing durability and preventing preservative leaching. End caps at the crosstie ends may further seal the wood, creating a preservative reservoir for slow diffusion and allowing for periodic replenishment, which extends the crosstie's lifespan and maintains structural integrity through innovative design.

### FIELD OF THE INVENTION

This invention relates generally to timber rail crosstie preservation.

### BACKGROUND OF THE INVENTION

Wood crossties are widely used in the railway industry despite being susceptible to microbial and fungal degradation, leading to high maintenance and repair costs.

Some prior art arrangements, such as disclosed in US20160089846A1 (Shoreline Plastics LLC et al.) 2016 Mar. 31, use mechanical barriers in the form of a plastic sleeve to form a durable and impervious membrane that prevent any attack on the substrate by boring and surface destroying organisms and substances.

Other prior art arrangements such as disclosed in US20080265047A1 (SUPERIOR RAIL SUPPORT Inc) 2011 May 17 teach a combination of plastic sleeves and wood preservative such as creosote, coal tar, or chromated copper arsenate to prevent these preservatives leaching to the surrounding environment and surrounding water tables.

It is to be understood that, if any prior art information is referred to herein, such reference does not constitute an admission that the information forms part of the common general knowledge in the art, in Australia or any other country.

### SUMMARY OF THE DISCLOSURE

There is described herein a process for the preservation of timber rail crossties by first treating them with an inorganic borate wood preservative, followed by wrapping the treated crossties in multiple layers of plastic sleeves.

Inorganic borate wood preservative has broad-spectrum effectiveness against bacteria, fungi, and insects, while demonstrating lower toxicity towards mammals as compared to compared to creosote and CCA (chromated copper arsenate) alternatives. CCA especially has high toxicity due to the presence of arsenic and chromium and is therefore subject to environmental restrictions.

This characteristic makes borate preservatives a safer alternative, particularly in contexts where reduced environmental impact and occupational health risks are prioritised. Furthermore, borates are water-soluble, which contributes to their efficacy in penetrating wood.

However, this solubility presents a challenge as it may readily leach from the wood when exposed to water. Boron compounds are highly leachable as compared to their water-soluble CCA counterparts.

It was found that even if the crosstie was covered in plastic, subsequent splitting or checking of the wood of the crosstie (especially for unseasoned wood) could cause the plastic to rupture, thereby allowing the highly leachable inorganic borate wood preservative to seep into the surrounding environment.

This problem seems to be caused by the plastic tightly integrating with woodgrain of other surface features of the crosstie thereby causing the plastic to rupture or split in the event of splitting or checking of the wood, a problem especially problematic for untreated wood.

As such, a less soluble wood preservative such as CCA or oil-based wood preservative such as creosote could be used to address this leaching problem.

However, according to the present arrangement, highly soluble inorganic borate wood preservative is used but wherein the multiple plastic layers encapsulate the inorganic borate wood preservative so that only the innermost layers tightly integrated with the wood surface features whereas outer layers interface increasingly interface smoother or uniform surfaces of inner layers, thereby not tightly integrating with the wood surface. As such, even if subsequent splitting or checking of the wood of the crosstie causes splitting of the integrally coupled inner plastic sleeve, the further outer layers of plastic sleeves may stretch rather than split on account of their interfacing the smoother or more uniform surfaces of inner plastic sleeves to thereby maintain the barrier integrity provided by the plurality of plastic sleeves to reduce or even substantially eliminate (depending on the number of layers) the risk of the highly soluble inorganic borate wood preservative leaching into the surrounding environment.

As such, the present arrangement derives the aforedescribed advantages of inorganic borate wood preservative whilst mitigating against problems of its highly leachable nature.

The sleeve plastic may be UV stabilised and may potentially comprising various types of plastics such as PVC, PE, POF, PP, PET, PETE, and PET-G to leverage their unique properties like stretchability and UV resistance.

In embodiments, end caps may be attached to the crosstie ends, sealing them to further prevent leaching into the environment.

These caps, which may be made of metal, rubber (e.g., silicone), or other materials, may fit snugly over the crosstie ends and may also be covered by the plastic sleeves for a sealed interface.

These end caps may form a reservoir at the crosstie ends which may be filled with wood preservative (potentially mixed with a gelling agent) to gradually diffuse through the wood, extending its service life and preserving its structural integrity.

The design may allow for the periodic replenishment of the wood preservative in the reservoirs, with end caps configured to be removable or designed to allow replenishment through methods such as injection via a hypodermic needle or through closable apertures, ensuring the long-term effectiveness of the preservation system.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 illustrates components for preservation of a timber rail crosstie;

FIG. 2 illustrates a heat shrinking apparatus 104 in accordance with an embodiment;

FIG. 3 shows an end view of the timber rail crosstie and associate componentry; and

FIG. 4 shows a process for preserving the crosstie.

### DESCRIPTION OF EMBODIMENTS

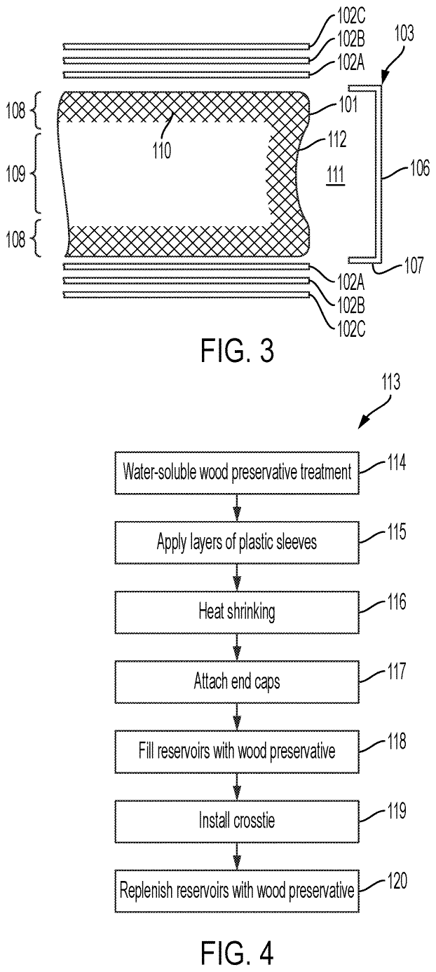

FIG. 4 shows a process 113 for preserving a timber rail crosstie 101.

The process 113 entails treating the crosstie 101 with a water-soluble wood preservative at step 114. Preferably, the water-soluble wood preservative is an inorganic borate preservative and further preferably copper borate type of preservative, such as Copper Hydroxide-Sodium Borate Wood Preservative. This type of inorganic borate preservative is highly soluble and therefore readily diffuses into the wood of the crosstie 101, as compared to its less soluble CCA or oil-based creosote alternatives. FIG. 3 shows the deep penetration 108 of the wood preservative 110 through the surface surrounding the heartwood 109 of the crosstie 101 on account of its highly soluble nature.

The process 113 further entails applying layers of plastic sleeves 102 around the wood preservative treated crosstie 101. FIG. 3 shows the crosstie 101 encapsulated within three layers of plastic sleeves 102 comprising an inner layer 102A, intermediate layer 102B and outer layer 102C.

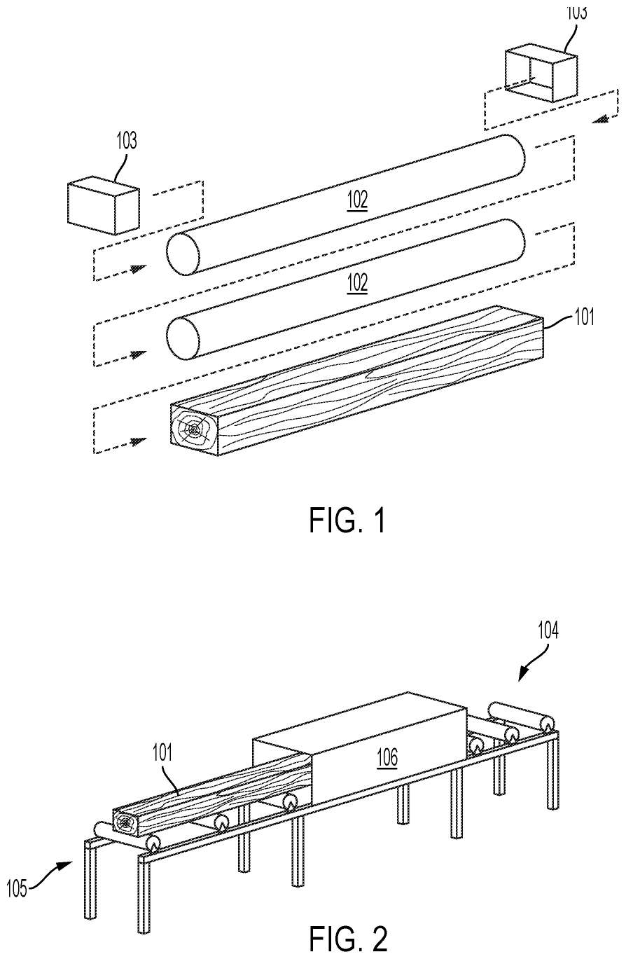

Preferably the basic sleeves 102 are tightly bound to the crosstie 101 to reduce or eliminate gaps for wood destroying insects, microbes or fungi. In this regard, applying the plastic sleeves 102 may comprise heat shrinking the plastic sleeves 102 around the crosstie 101. FIG. 1 shows a series of plastic sleeves 102 which are larger than the crosstie 101 and which are placed around the crosstie 101 whereafter heat is applied to cause the plastic sleeves 102 to shrink by 25% or more to tightly encapsulate the crosstie 101.

FIG. 2 shows heat shrinking apparatus 104 comprising the conveyor 105 of rollers which feed the crossties 101 through a heat tunnel 106 (which may be electrical gas-fired) to shrink the plastic sleeve 102.

Preferably, each plastic sleeve 102 is shrunk independently around the crosstie 101. In other words, each plastic sleeve 102 is heat shrunk around the crosstie 101 prior application of another plastic sleeve 102.

Heat shrinking causes the plastic sleeve 102 to tightly compress against the crosstie 101. With reference to FIG. 3, the inner plastic sleeve 102A may therefore tightly integrate with the grain and any wood splits or checks, thereby essentially being integrally formed with the crosstie 101.

However, the further layers of plastic sleeves 102 interface increasingly smoother or uniform surfaces of inner plastic sleeves 102. As such, these outer plastic sleeves 102 do not tightly integrate with the grain and any wood splits or checks of the crosstie 101 and are therefore essentially non-integrally formed with the crosstie 101.

As such, even if subsequent splitting or checking of the wood of the crosstie 101 causes splitting of the integrally formed inner plastic sleeve 102, the further outer layers of plastic sleeves 102 may stretch rather than split on account of their interfacing the smoother or more uniform surfaces of inner plastic sleeves 102 to thereby maintain the barrier integrity provided by the plurality of plastic sleeves 102. As such, the additional layers of plastic sleeves 102 may reduce or even substantially eliminate (depending on the number of layers) the likelihood of barrier compromise and therefore risk of leaching of the water-soluble wood preservative into the surrounding environment, especially highly leachable inorganic borate preservative.

In this regard, it is preferred that three or more layers of plastic sleeves 102 are applied around the crosstie 101.

On account of the plastic sleeves 102 ability to accommodate subsequent cracking or checking post installation of the crosstie 101, the process 113 may therefore be applied to freshly sawn (i.e. untreated) timber, thereby drastically reducing production timeframes and cost.

Preferably the sleeves 102 comprise UV stabilised plastic.

In embodiments, the sleeves 102 comprise polyvinyl chloride (PVC). However, in alternative embodiments, other types of plastic are envisaged, including polyethylene (PE), polyolefin (POF) polypropylene (PP) and polyethylene terephthalate in both amorphous and crystalline form (PET, PETE, PET-G) films.

In embodiments, the sleeves 102 comprise different types of plastic, to thereby take advantage of differing associated properties of the different types of plastic, such as in terms of stretchability, UV resistance and the like.

Preferably the sleeves 102 have sufficient length to cover the ends of the crosstie 101 to prevent leaching from the ends of the crosstie 101.

At step 117, end caps 103 may be attached to ends of the crosstie 101. These end caps 103 seal the ends of the crosstie 101 and thereby prevent leaching of the water-soluble wood preservative into the surrounding environment.

With reference to FIG. 3, the end cap 103 may comprise a plate 106 and a flange 107 which is shaped according to the cross-section of the crosstie 101 so that the end cap 103 fits snugly onto the end of the crosstie 101.

In embodiments, the plastic sleeves 102 cover the flange 103 after installation of the end cap 106 to thereby provide an adequately sealed interface between the sleeves 102 and each end cap 106. In accordance with this arrangement, the end caps 106 may be applied to the ends of the crosstie 101 prior heat shrinking whereafter any extraneous ends of the plastic sleeves 102 are trimmed.

In one embodiment, the end caps 106 are metallic. In alternative embodiments, the end caps 106 are rubber, such as silicon.

The end cap 106 may form a reservoir 111 at the end of the crosstie 101 which are filled with wood preservative at step 118 which gradually diffuses through the ends of the crosstie 101 over time. Wood preservative in the reservoir 111 may be mixed with a gelling agent to form a type of paste which can be more easily installed in the reservoir 111 without leakage.

As is shown in FIG. 3, an end of the crosstie 101 may be machined to form a cavity 111 thereby forming the reservoir 111.

At step 119 the crosstie 101 is installed in a railway bed in the conventional manner wherein its service life is extended by the advantageous properties of the inorganic borate wood preservative including the ability to deeply penetrate the wood of the crosstie. Furthermore, the plastic sleeves 102 prevent leaching of the highly soluble inorganic borate wood preservative to the surrounding environment.

Furthermore, the plastic sleeves 102 (potentially in conjunction with the end caps 106) uniformly maintains the moisture content of the crosstie to reduce or eliminate likelihood of splitting or checking on account of non-even drying.

As also alluded to above, the multiple layers of plastic sleeves 102 may mitigate against splitting of the plastic barrier formed thereby on account of subsequent splitting or checking of the wood of the crosstie 101, especially for unseasoned crossties.

At step 120, the reservoirs 111 may be periodically replenished. In this regard, the end caps 106 may be configured to be removable so that the reservoirs 111 may be periodically replenished. Alternatively, where the end caps 106 comprise rubber, a hypodermic needle may be used to pierce the end cap 106 to replenish the reservoir 111. Alternatively, the end caps 106 may comprise closable apertures for replenishment of wood preservative.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A timber rail crosstie preservation method comprising treating the crosstie with an inorganic borate wood preservative and then applying layers of plastic sleeves around the crosstie to fully encapsulate the crosstie, wherein the plastic sleeves are heat shrunk around the crosstie when the crosstie is unseasoned.

2. The preservation method as claimed in claim 1, wherein the inorganic borate wood preservative is copper borate.

3. The preservation method as claimed in claim 1, wherein three or more layers of plastic sleeves are applied.

4. (canceled)

5. (canceled)

6. (canceled)

7. The preservation method as claimed in claim 1, wherein each plastic sleeve comprises a different type of plastic.

8. The preservation method as claimed in claim 1, wherein the plastic sleeves comprise UV stabilised plastic.

9. The preservation method as claimed in claim 1, wherein the plastic sleeves comprise polyvinyl chloride (PVC).

10. The preservation method as claimed in claim 1, wherein the plastic sleeves comprise at least one of polyvinyl chloride (PVC), polyethylene (PE), polyolefin (POF), polypropylene (PP), and polyethylene terephthalate in both amorphous and crystalline form (PET, PETE, PET-G) films.

11. The preservation method as claimed in claim 1, further comprising attaching a non-permeable end cap to create a preservative reservoir at an end of the crosstie.

12. The preservation method as claimed in claim 11, wherein the end cap comprises a plate and a flange, and wherein the flange is shaped according to a cross-section of the crosstie.

13. The preservation method as claimed in claim 12, wherein the plastic sleeves cover the flange.

14. The preservation method as claimed in claim 13, wherein the end cap is attached to the end of the crosstie prior to heat shrinking of the plastic sleeves.

15. The preservation method as claimed in claim 11, wherein the end cap is removably attached to the end of the crosstie.

16. The preservation method as claimed in claim 11, wherein the end of the crosstie is machined to form a cavity defining the preservative reservoir.

17. (canceled)

18. The preservation method as claimed in claim 16, wherein the preservative reservoir comprises a mixture of the wood preservative and a gelling agent.

19. The preservation method as claimed in claim 18, wherein the preservative reservoir at the end of the crosstie is periodically replenished with the wood preservative.

20. The preservation method as claimed in claim 15, wherein the end cap is pierced with a hypodermic needle to inject wood preservative into the preservative reservoir.

21. The preservation method as claimed in claim 15, wherein the end cap comprises an aperture for replenishment of the wood preservative.

22. The preservation method as claimed in claim 15, wherein the end cap is removably attached to the end of the crosstie and wherein the end cap is periodically removed to replenish the wood preservative.

23. A timber rail crosstie, wherein the crosstie is treated with an inorganic borate wood preservative and surrounded by layers of plastic sleeves to fully encapsulate the crosstie, wherein the plastic sleeves are heat shrunk around the crosstie when the crosstie is unseasoned.
